(19) United States
(12) Patent Application Publication
(10) Pub. No.: US 2004/0256880 A1
(43) Pub. Date: Dec. 23, 2004

(54) Four seasons lenses of sun visor for vehicles

(76) Inventor: Xiao-Dong Jack She, Ottawa (CA)

Correspondence Address: Xiao-Dong Jack SHE, 311 Bell St. S. Apt. 609, Ottwa, ON, K1S AK1, CA

(21) Appl. No.: 10/858,633

(22) Filed: Jun. 1, 2004

Related U.S. Application Data
(63) Continuation-in-part of application No. PCT/CA03/00010, filed on Apr. 11, 2003.

(30) Foreign Application Priority Data
Mar. 26, 2002 (CA) 2,384,684

(51) Int. Cl. B60J 3/04

(52) U.S. Cl. 296/97.2

(57) ABSTRACT

Four seasons lenses of sun visor for vehicles comprising a frame or multiframes have four seasons lenses: 1. Spring lens, 2. Summer lens, 3. Autumn lens, 4. Winter lens. The frame(s) according to seasons sequence to in turn change season lens of correspond: in spring to use spring lens, in summer to use summer lens, in autumn to use autumn lens, in winter to use winter lens. The rotate system of four seasons lenses which is according to four seasons of different sun illuminative intensity to divide and to be made up; they can applicable to all kinds seasons of whole year; raised vision clarity and quality of the lenses at all kinds of seasons; vision and block sun of effects are stable and standard, drivers do not need one side driving meanwhile one side to adjust the lens in driving; convenient use and raised safety function. The seasons lenses possess function of protect eyes sight of high class soft chroma. Every driver can change seasons lenses oneself.

### BACKGROUND OF THE INVENTION

1. Field of the Invention

The invention is relates to an improved sun visor for vehicles which don't need to adjust lens in driving, four seasons all have stable and standardize visual sense effects.

2. Description of the Prior Art

The prior art disclose a lot of and various sun visor, their basic and main of characteristics are:

(1) Various sun visor which are extendable horizontally intended to help and replenish vehicles sun visor to block sun.

(2) Various sun visor which are extendable vertically intended to help and replenish vehicles sun visor to block sun.

(3) Adjustable three lenses triangular structure of visor.

(4) Adjustable two lenses circular opening concentric structure of sun visor. etc.

3. The Problems of Today and Solve of Way:

(1) Now whole world commn use of various vehicles sun visor neither whole block the sun glare, nor use It to see any of the road traffic situation, the sun visor is only a board, It can not more function, every time the sun glare irradiate into drivers eyes, drivers still difficult to open eyes, still difficult to see clear the road traffic situation.

(2) The adjustable lenses sun visors have big progress, but adjust lens in driving, sometime will cause the confusion, nervous, mistake etc. sometime more adjust more far leave the need; the speed more faster, and face to the sun glare more strong, adjust more difficult and danger. may be do not adjust, stable season lens more safety and more better. I have found that these disadvantages maybe overcome by providing a four seasons lenses of sun visor for vehicles which can four seasons all have stable and standardize visual sense and block sun effects; drivers don't need one side driving meanwhile one side to adjust lens; It is more safety, better visual quality and more convenient when to use It.

4. The World Markets of the Present Invention:

(1) Every year in late spring or summer or autumn, so many cars turned down the sun visor for block sun; meanwhile so many drivers are wearing sunglass when they are driving various vehicles; and other side, a lot of drivers have already wearing spectacle for myopia eyes, they need sun-glass too, but difficult to add it which will hevy and not convenience, etc.

(2) Every year have happened a lot of vehicles traffic accidents, in period, partly concerned with the problem of block sun and the problem of visibility.

(3) Above of situations have explained:

A. These are using of various vehicle sun visor need to improve.

B. Vehicle drivers need new improved product, and safe driving need new improved product.

C. The present invention which the four seasons lenses of sun visor for vehicles possess these new improved functions and advantages, maybe can suitable this situations and need.

D. The present invention markets of the whole world will be very huge, hot, and people will like it very much, and the foreground will be very good.

### SUMMARY OF THE INVENTION

1. The object of the present invention is to provides an improved sun visor for various vehicles.

2. The present invention comprising a frame or multiframes have four seasons lenses.

3. The four seasons lenses are: (1) spring lens, (2) summer lens, (3) autumn lens, (4) winter lens.

4. The frame(s) are according to seasons change of sequence to replace and to use correspond of season lens: (1) In spring to use spring lens, (2) in summer to use summer lens, (3) in autumn to use autumn lens, (4) in winter to use winter lens.

5. Under four seasons lenses, can every season all have stable and standardize visual effect and block sun effect; drivers don't need one side driving meanwhile one side to adjust lens; it is more safety; more better visual quality; and more convenient when to use it. etc.

6. The four seasons lenses are according to spring, summer, autumn, winter four seasons of different sun illuminating intensity and different district to classify and to make up four each other different degree of block sun of seasons lenses.

7. The four seasons lenses are choosed multiplicity colours to mix in material, possess protect eyes sight of high class soft chroma of functions.

8. Whenever, before the sun glare irradiate into drivers eyes, to turn down the sun visor of four seasons lenses, the driver's view of eyes to pass through the season lens to see clear the road traffic situations. after use, to turn up the sun visor of four seasons lenses to standard model.

### BRIEF DESCRIPTION OF THE DRAWINGS

FIG. 1 is a multiframes of illustrates view embodiment of the present invention.

FIG. 2 is an illustrates working view of the present invention.

FIG. 3 is a frame of illustrates view embodiment of the present invention.

### DETAILED DESCRIPTION OF THE DRAWINGS

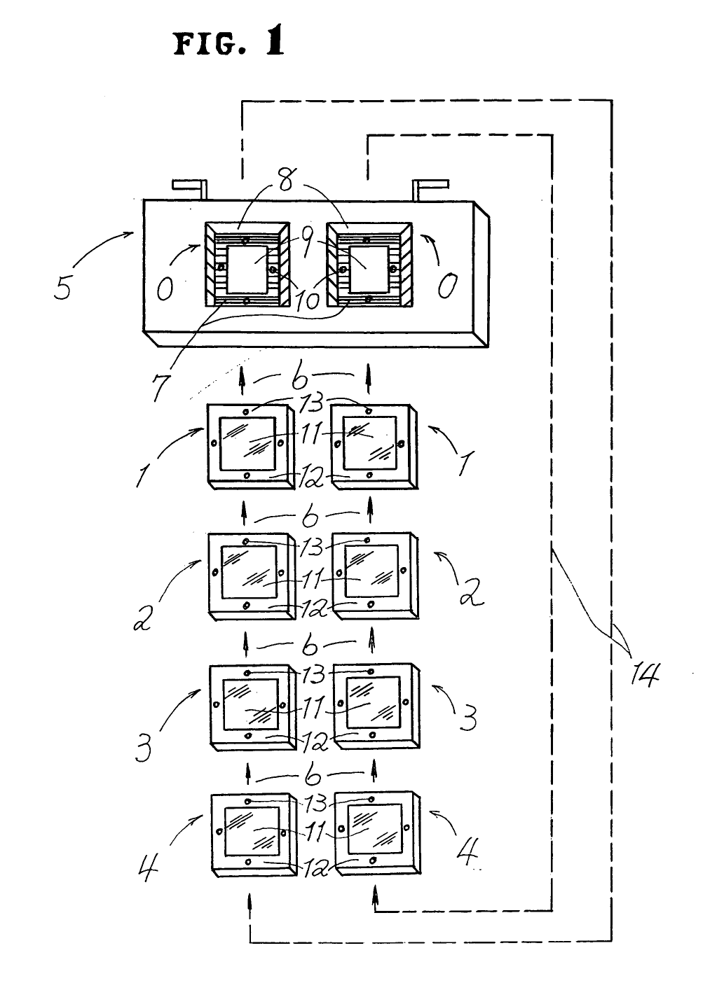

FIG. 1 illustrates the four seasons lenses sun visor 5 comprising two frames 0 have four seasons lenses: Spring lens 1; Summer lens 2; Autumn lens 3; Winter lens 4. the frames 0 according to seasons change of sequence to change or to use correspond of season lens: In spring to use spring lens 1; in summer to use summer lens 2; in autumn to use autumn lens 3; in winter to use winter lens 4. The season lens from the direction of change 6 to change position 7. four seasons lenses 1, 2, 3, 4 along the working line 14 to cycles. the hollow place 8 around the change of position 7. The driver's view pass through the season lens 11 and view exit 9 to see clear the road situations. On the bind edge of seasons lenses 12 have the install screws 13 to the install holes 10.

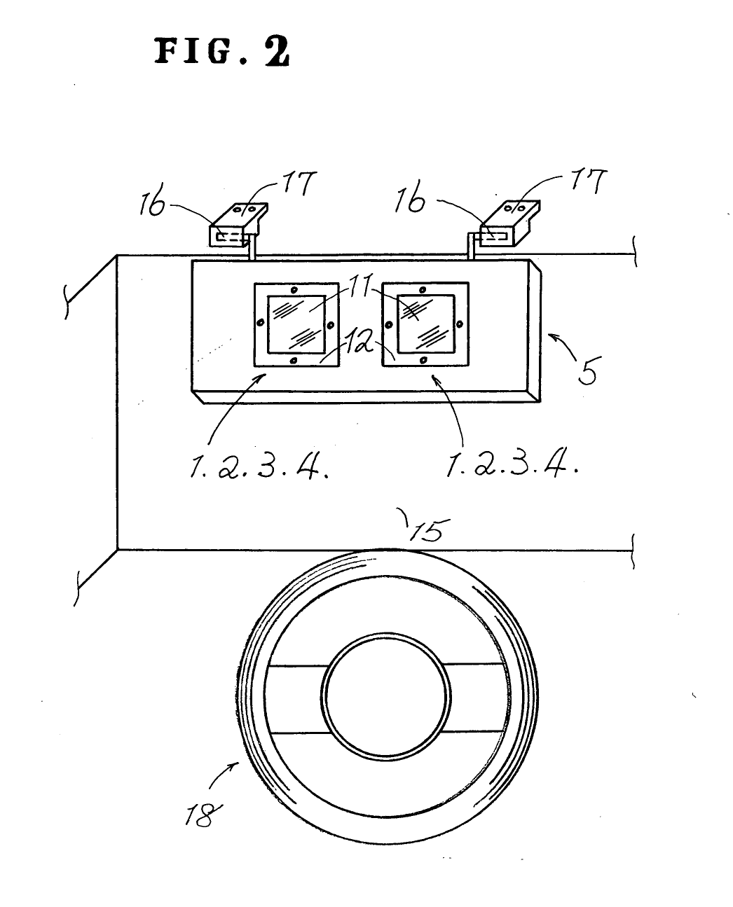

FIG. 2 illustrates the inside of a car, in which on the four seasons lenses sun visor 5 installed two season lens 11, the 12 is bind edge of season lens. The seasons lenses have four seasons: Spring lens 1, Summer lens 2, Autumn lens 3, Winter lens 4. according to seasons change of sequence to install correspod of season lens 1, 2, 3, 4. The two turn axles 16 in the two seats 17, for sun visor 5 to turn down or turn up. The 15 is windshield, the 18 is steering wheel.

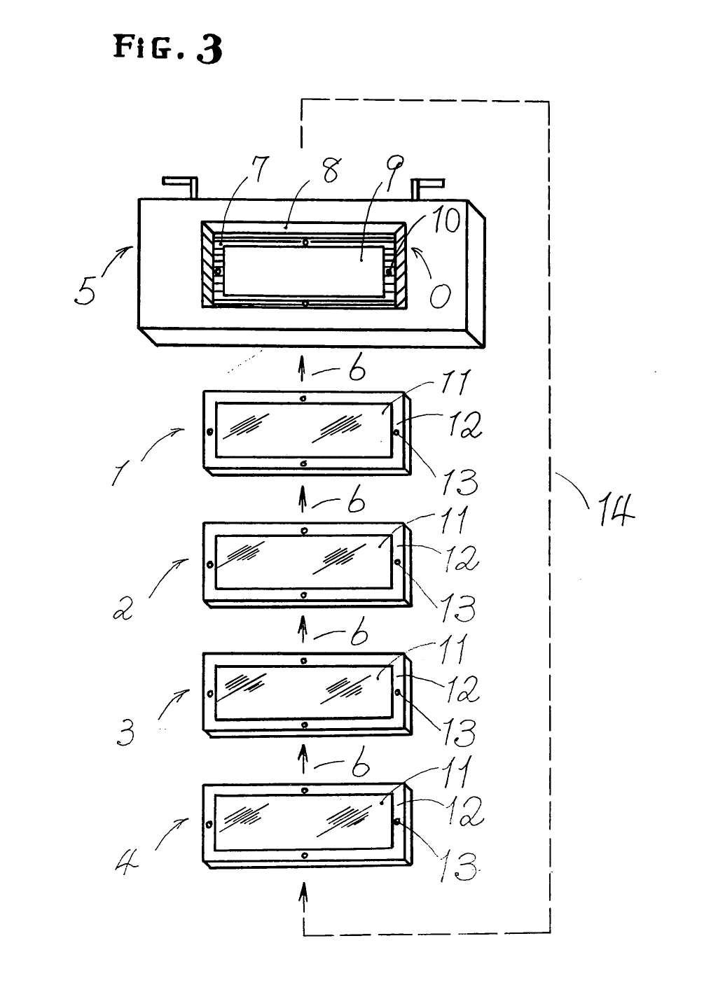

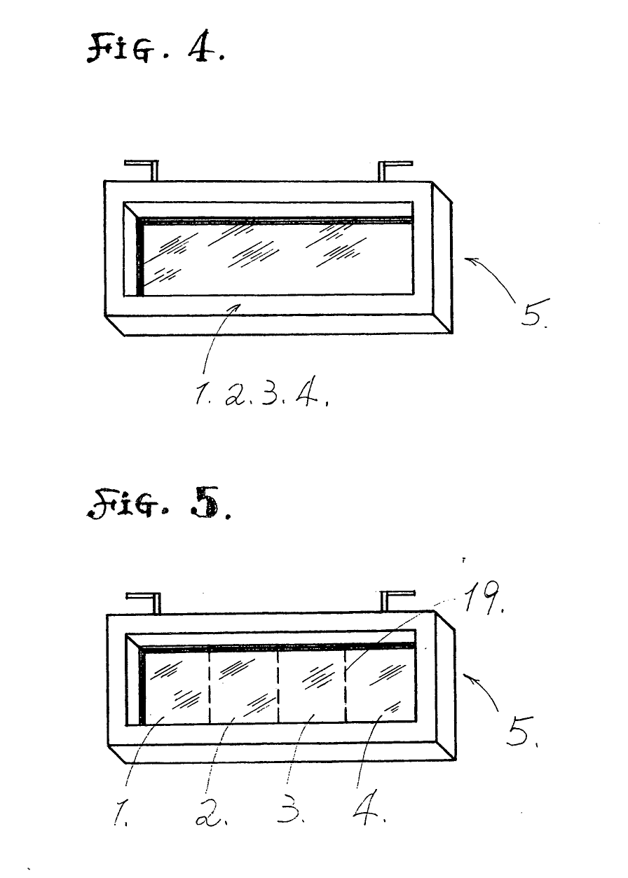

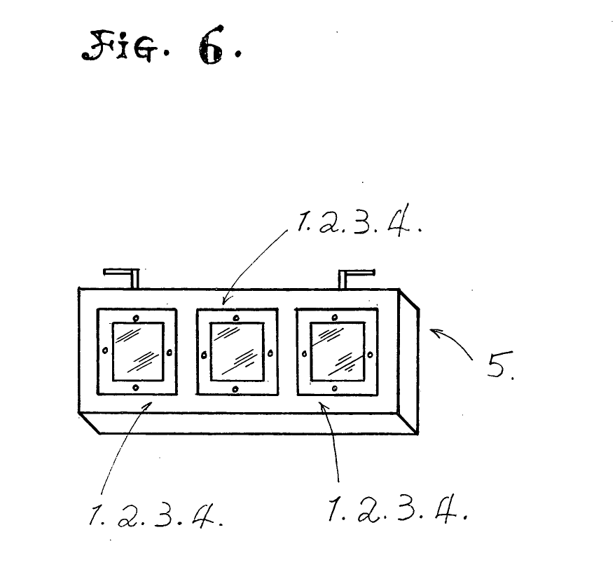

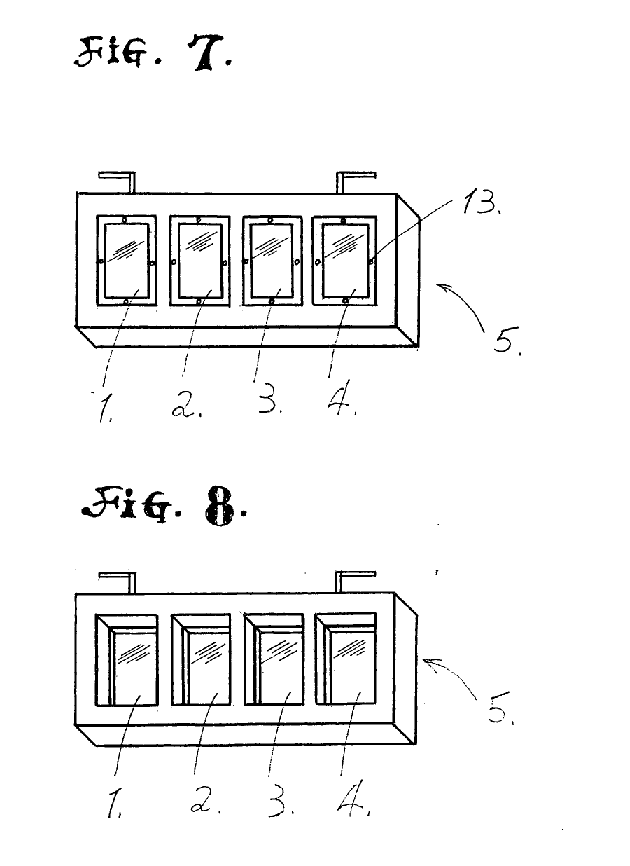

FIG. 3 is same to FIG. 1, only different is that: FIG. 3 is a frame of sun visor, FIG. 1 is multiframes of sun visor. Illustrated application process to four seasons lenses of sun visor for vehicles

Whenever, for block the sun glare irradiate into the driver's eyes, to turn down the sun visor 5, the driver's view of eyes to pass through the season lens 11 to see clear the road traffic situations. after use, to turn up the sun visor 5 to standard model. the seasons lenses have four seasons: Spring lens 1, Summer lens 2, Autumn lens 3, Winter lens 4. according to seasons change of sequence to install correspond of season lens, along the working line 14 to cycles use. The four seasons lenses of sun visor for vehicles has a frame or multiframes of different types.

I claim:

1-5. Cancelled

6. Four seasons lenses of sun visor for vehicles comprising: a frame or multiframes have four seasons lenses: (1) Spring lens; (2) Summer lens; (3) Autumn lens; (4) Winter lens.

7. Four seasons lenses of sun visor for vehicles as in claim 6 in which the frame according to seasons change of sequence to replace and to use correspond of season lens: (1) Spring to replace and to use spring lens; (2) Summer to replace and to use summer lens; (3) Autumn to replace and to use autumn lens (4) Winter to replace and to use winter lens.

8. Four seasons lenses of sun visor for vehicles as in claim 6 in which the four seasons lenses are according to spring, summer, autumn, winter, four seasons of different sun illuminating intensity and different district to classify and to make up four each other different degree of block sun of seasons lenses; for four seasons all have stable and standardize vision effects; and more safety, more convenient effects when to use it; driver don't need one side driving meanwhile one side to adjust lens.

9. Four seasons lenses of sun visor for vehicles as in claim 6 in which the four seasons lenses are choice multiplicity colours to mix in material, possess protect eyes sight of high class soft chroma of functions.
